(19) United States
(12) Patent Application Publication
(10) Pub. No.: US 2023/0373205 A1
(43) Pub. Date: Nov. 23, 2023

(54) SYSTEMS AND METHODS FOR THERMAL TRANSFER OF PATTERNS TO A SUBSTRATE

(71) Applicant: Mr. Bar-B-Q Products LLC, Hauppauge, NY (US)

(72) Inventor: Marc Zemel, Hauppauge, NY (US)

(21) Appl. No.: 18/199,297

(22) Filed: May 18, 2023

Related U.S. Application Data
(60) Provisional application No. 63/343,152, filed on May 18, 2022.

(51) Int. Cl. B41F 16/00

(52) U.S. Cl. CPC B41F 16/00

(57) ABSTRACT

A system for thermal transfer of a pattern on a substrate includes a thermoplastic polymer paper configured for adhering to the substrate using a reactive polymer, a sponge material configured for fixing the paper to the substrate, and an oven configured for baking the substrate for a predetermined period of time for a temperature lower than a predetermined temperature to cure or set the pattern on the substrate. Methods for the thermal transfer of a predetermined pattern on a substrate are also provided.

### CROSS REFERENCE TO RELATED APPLICATIONS

The present application claims the benefit of and priority to U.S. Provisional Application No. 63/343,152, filed on May 18, 2022, the entire contents of which is hereby incorporated by reference in its entirety.

### TECHNICAL FIELD

This disclosure relates to thermal image transfer, and more particularly, to systems and methods for thermal image transfer of designs to a substrate comprised of metal such as steel, bronze, and/or aluminum.

### BACKGROUND

Currently, hydro printing inks are used to print décor by a multicolor printing press with rollers onto a pre-sealed core, and the print is covered with a protective transparent wear layer that may be an overlay, a plastic foil, or a lacquer. The production process is rather complicated and is only cost-efficient in very large production volumes.

Accordingly, improvements are needed to provide an efficient method of transferring patterns to substrates such as those comprised of metal.

### SUMMARY

In accordance with aspects of this disclosure, a method for thermal transfer of patterns on a substrate includes printing a design with an ink on a thermoplastic polymer-based paper, applying the paper to the substrate using a reactive polymer, fixing the paper to the substrate using sponge material and adhesive to attach the sponge material to the substrate, and baking the substrate for a predetermined period of time and for a temperature lower than a predetermined temperature to cure or set the desired design onto the substrate.

In an aspect of this disclosure, the method may further include removing the paper from the substrate.

In an aspect of this disclosure, the reactive polymer may include an epoxy resin.

In another aspect of this disclosure, the substrate may include metal such as steel, aluminum, bronze, and/or combinations thereof.

In yet another aspect of this disclosure, the paper may comprise polypropylene and include the design.

In a further aspect of this disclosure, the paper may be flat with no texture.

In yet a further aspect of this disclosure, the design may include a wood grain design, a faux stone, or rock design.

In an aspect of this disclosure, the predetermined period of time to cure the design onto the substrate may be about 20 minutes.

In another aspect of this disclosure, the predetermined temperature to cure the design onto the substrate may be about 175 to about 185° C.

In yet another aspect of this disclosure, the method may further include capturing an image of a desired pattern to use as the design, prior to printing the design on the thermoplastic polymer paper.

In accordance with aspects of this disclosure, a system for thermal transfer of patterns on a substrate, includes a thermoplastic polymer paper configured for adhering to the substrate using a reactive polymer, a sponge material configured for fixing the paper to the substrate, and an oven configured for baking the substrate for a predetermined period of time and for a temperature lower than a predetermined temperature. The paper may include a predetermined and desired design.

In an aspect of this disclosure, the system may further include an image capture device configured to capture an image of a wood grain pattern or any other desired pattern to use as the design.

In an aspect of this disclosure, the reactive polymer may include an epoxy resin.

In another aspect of this disclosure, the substrate may comprise metal such as steel, bronze, aluminum, and combinations thereof.

In yet another aspect of this disclosure, the paper may include a predetermined and desired design.

In a further aspect of this disclosure, the paper may be flat and smooth with no texture.

In yet a further aspect of this disclosure, the design may include a faux wood grain design, or a faux stone or rock design.

In an aspect of this disclosure, the predetermined period of time to cure the design onto the substrate may be about 20 minutes.

In another aspect of this disclosure, the predetermined temperature to cure the design onto the substrate may be about 175 to about 185 degrees C.

In another aspect of this disclosure, the desired and predetermined design may be printed with ink on the thermoplastic paper by a printing machine.

Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying figures of which:

FIG. 1A is an image of a substrate with a layer of adhesive applied to the substrate in preparation for application of the thermoplastic polymer paper;

FIG. 1B is an image of the substrate of FIG. 1 illustrating the thermoplastic polymer paper being applied to the substrate, in accordance with the principles of this disclosure;

FIG. 2A is an image illustrating multiple substrates with thermoplastic polymer paper fixed thereto with sponge material surrounding the paper on the substrate, in accordance with the principles of this disclosure;

FIG. 2B is an image illustrating the sponge material of FIG. 2A being affixed using strapping, in accordance with the principles of this disclosure;

FIG. 3 is an image of multiple substrates of FIG. 1 hanging and being baked in an oven, in accordance with the principles of this disclosure;

FIG. 4 is an image of the thermoplastic polymer paper being removed from the substrate of FIG. 1 to expose the transferred pattern, in accordance with the principles of this disclosure; and

FIG. 5 is a flow diagram of a method for thermal transfer of patterns to a substrate, in accordance with the principles of this disclosure.

Other aspects, features, and advantages will be apparent from the description, the drawings, and the claims that follow.

### DETAILED DESCRIPTION

This disclosure relates to thermal image transfer, and more particularly, to systems and methods for thermal image transfer of designs to substrates comprising metal such as steel, aluminum, bronze, and combinations thereof.

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure, any features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

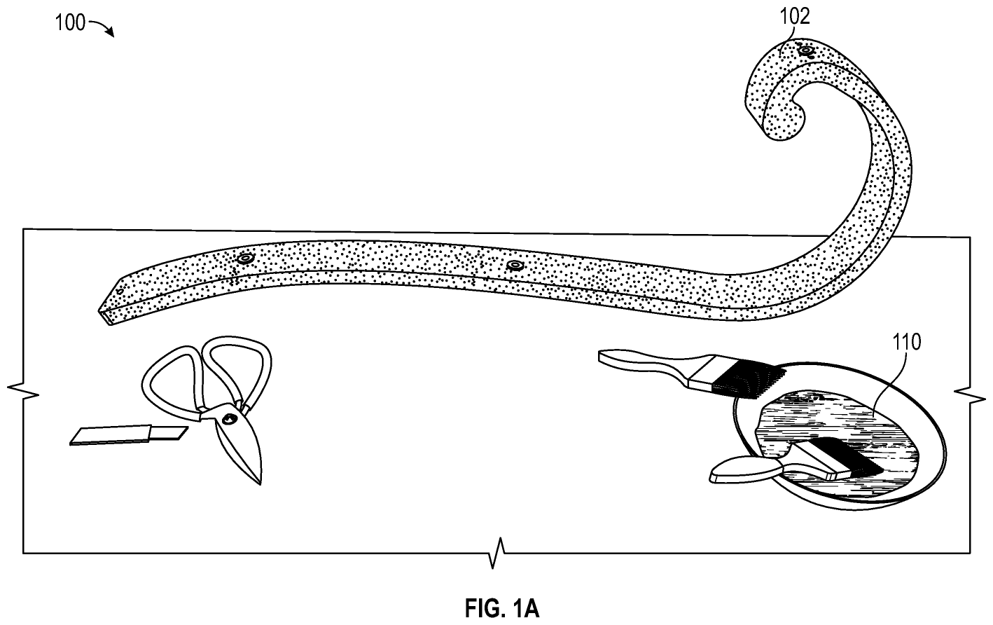

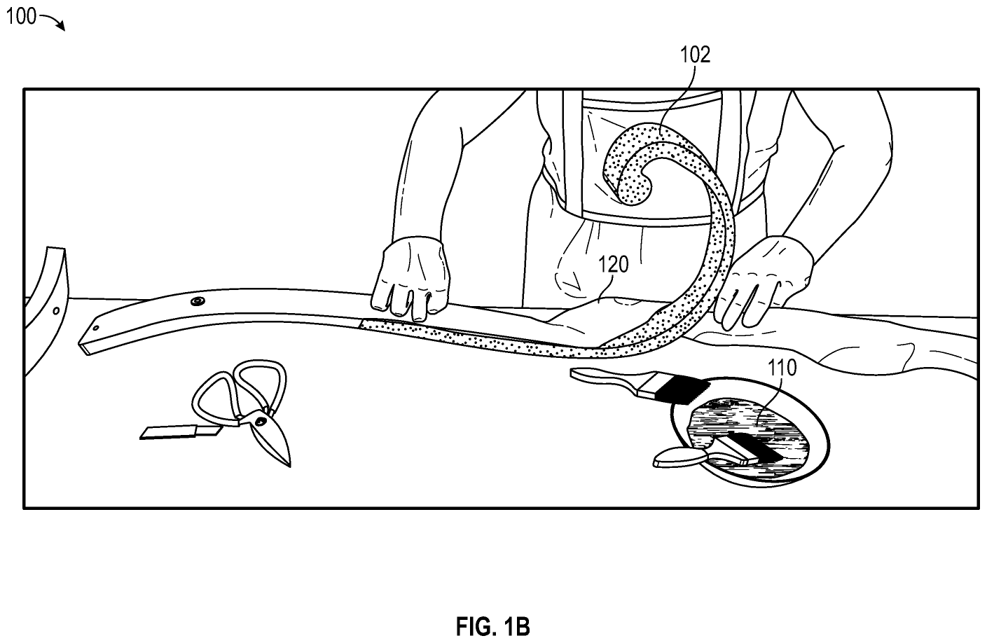

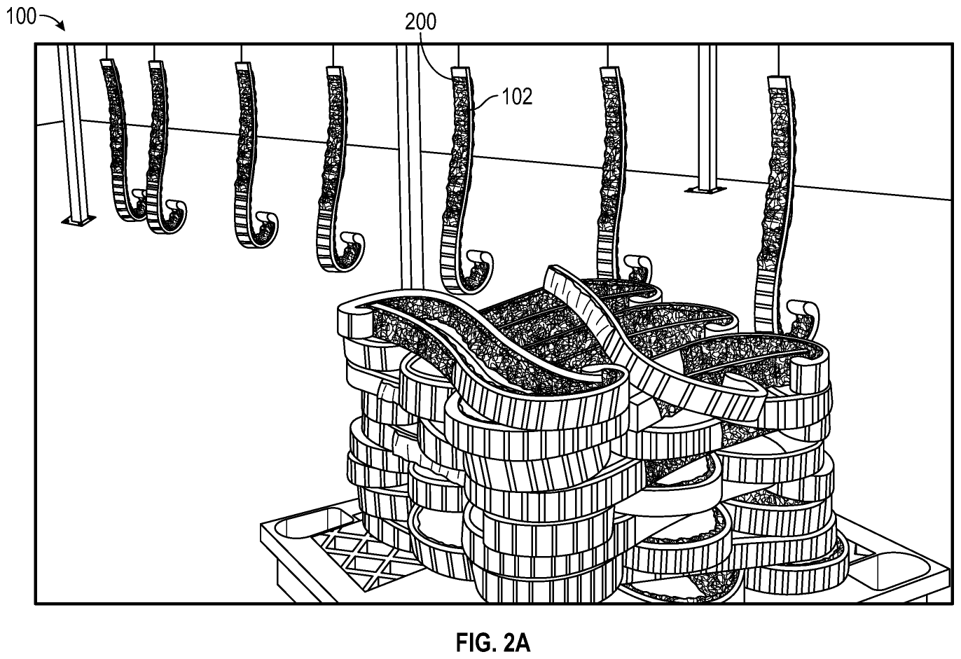

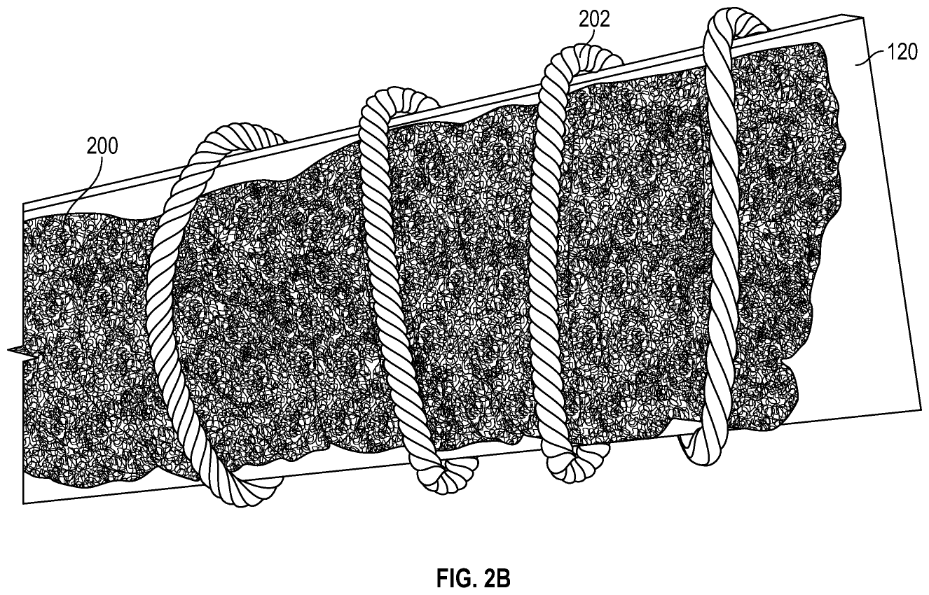

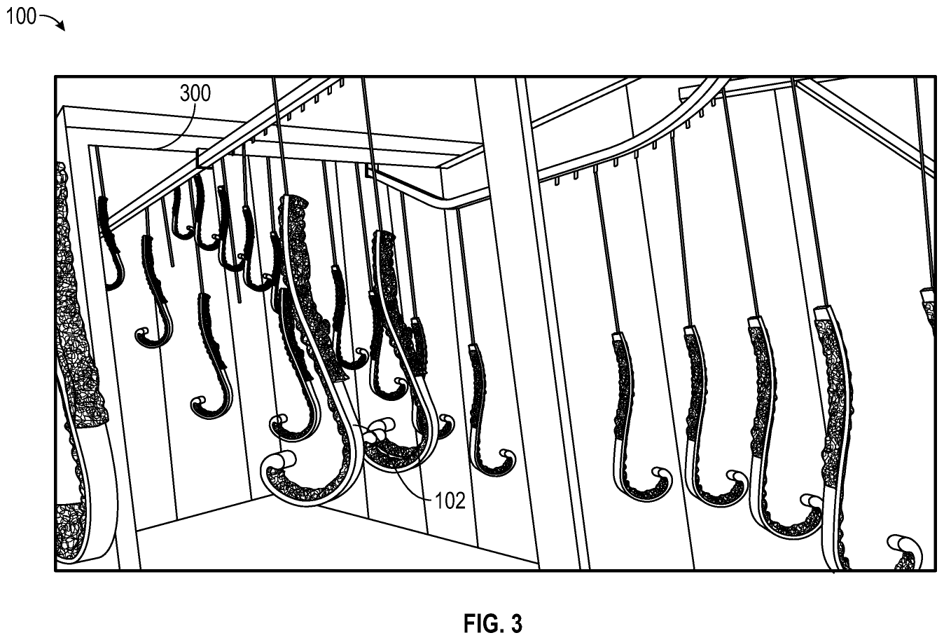

Referring to FIGS. 1A, 1B, and 2-4, a system 100 for thermal transfer of patterns on a substrate 102 is shown. The system 100 for thermal transfer of patterns on a substrate 102 generally includes a paper 120 (e.g., a thermoplastic polymer) configured for adhering to the substrate 102 using a reactive polymer 110 (FIGS. 1A and 1B), a sponge material 200 configured for fixing the paper 120 to the substrate 102 (FIG. 2A), and an oven 300 (FIG. 3) configured for baking the substrate 102 to cure or set the pattern onto the substrate.

The paper 120 may include a design printed on it. The design may be printed with an ink on the paper 120 by a printing machine. The design may include a wood grain pattern, a faux rock or stone pattern, faux ceramic tile, faux granite, faux marble, and/or other desirable patterns. The paper 120 may comprise polypropylene and is a smooth, flexible sheet of tear-resistant, scratch-resistant paper.

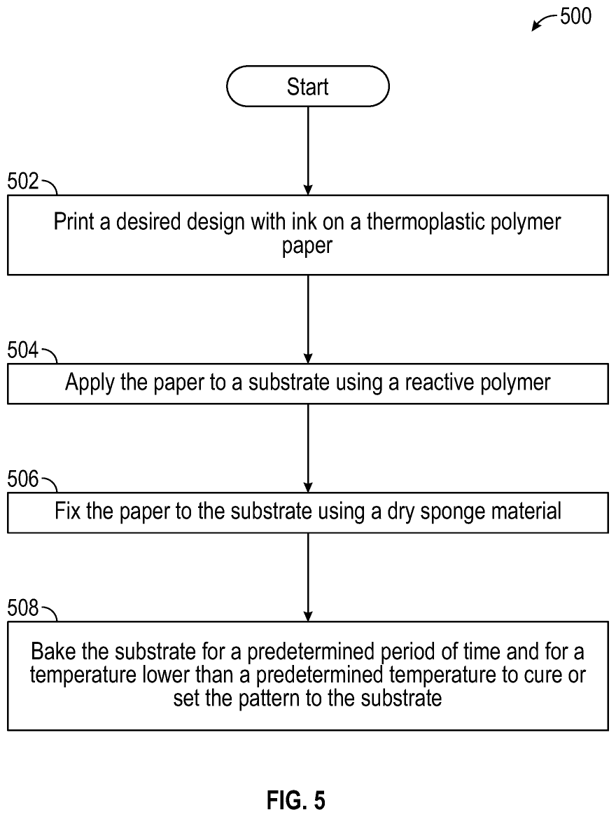

FIG. 5 shows a flow chart illustrating the various operations of an exemplary method for thermal transfer of patterns to a substrate 102, such as metal. The metal may comprise steel, aluminum, bronze, combinations thereof, or any other suitable metal known in the art. Persons skilled in the art will appreciate that one or more operations of the method 500 may be performed in a different order, repeated, and/or omitted without departing from the scope of the disclosure. Other variations are contemplated to be within the scope of the disclosure. The disclosed technology has the benefit of enabling the thermal transfer of designs on substrates such as metal.

Initially, at step 602, a design is printed with an ink on a paper 120. In aspects, the design includes a wood grain design. It is contemplated that other designs and patterns may be used. In aspects, the paper 120 is flat and smooth and has no texture. In aspects, the image of a wood grain pattern, to use as the design, may be captured using an imaging device, prior to printing the design on the paper 120. The substrate 102 may include any metal suitable to print a pattern thereon through thermal transfer, such as steel of any suitable grade.

Next, at step 604, the paper 120 is applied to the substrate 102 using a reactive polymer 110 (FIGS. 1A and 1B). In aspects, the reactive polymer 110 includes an epoxy resin. The reactive polymer 110 may be applied to the substrate 102 using, for example, a paintbrush, a sponge, or other suitable means. The paper 120 is then applied to the substrate 102 that is coated with the reactive polymer 110, while the reactive polymer 110 is still wet. For example, the reactive polymer 110 may be about 0.08 to about 0.1 mm thick when applied to the substrate 102, however, additional layers of coating may be applied if necessary. In aspects, the substrate 102 may be, for example, a component of a larger object, such as a fire pit mantel.

Next, at step 606, the paper 120 is fixed to the substrate 102 using a sponge material 200 (FIG. 2A). The sponge material 200 may be fixed onto the paper 120 on the substrate 102 using strapping 202 (FIG. 2B) such as rubber bands, rope (e.g., bast fiber crops such as ramie, jute, hemp, flax, apocynum, and/or bestia), wire, or any other means configured to stop paper 120 from falling off substrate 102 during processing and configured to withstand temperatures of at least 200° C. For example, the sponge material 200 may be affixed to the paper 120 on the substrate 102 by ropes or rubber bands. Alternatively, sponge material 200 may be fixed onto the paper 120 on the substrate 102 using adhesive or any other means as long as the materials can withstand temperatures of at least 200° C. In aspects, the sponge material 200 is “dry” at the time of fixing. It is contemplated that material other than a sponge may be used to hold the paper 120 onto the substrate 102 while processing the substrate 102, such as thermoplastic foams, open cell foams, expanded polyethylene (EPE) membranes, and any other soft materials known in the art which can protect the substrate from damaging or crushing the paper 120. The material must be soft and be able to endure high temperatures of at least 200° C.

Next, at step 608, the substrate 102 is baked for a predetermined period of time and for a temperature lower than a predetermined temperature (FIG. 3) to cure or set the pattern onto substrate 102. In aspects, the predetermined period of time may be about 18 to about 22 minutes. In aspects, the predetermined temperature may be about 175 to about 185° C. In aspects, the predetermined time may be about 20 minutes at a predetermined temperature of about 180° C. In aspects, the oven may include, for example, a belt oven and/or an oven chamber. In aspects, if more than one substrate 102 is going to be baked, the substrate 102 may be hung individually and sent through an oven room/house. For example, the substrate 102 may move through the oven room/house at a rate of about 5 meters per minute.

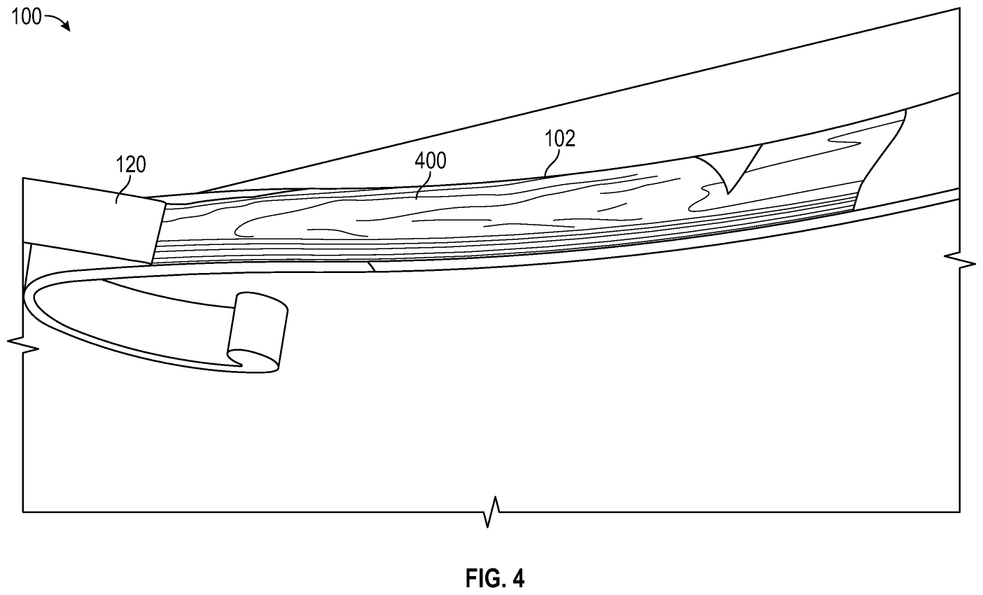

After baking, the paper 120 is removed from the substrate 102 to expose the transferred pattern (FIG. 4).

As can be appreciated, securement of any of the components of the disclosed systems can be effectuated using known securement techniques such welding, crimping, gluing, fastening, etc.

The phrases “in an aspect,” “in aspects,” “in various aspects,” “in some aspects,” or “in other aspects” may each refer to one or more of the same or different aspects in accordance with the present disclosure. Similarly, the phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A method for thermal transfer of a pattern on a substrate, comprising:
printing a predetermined design on a thermoplastic polymer paper;
applying the paper to the substrate using a reactive polymer;
fixing the paper to the substrate; and
baking the substrate for a predetermined period of time and for a temperature lower than a predetermined temperature.

2. The method of claim 1, wherein the fixing the paper to the substrate includes applying and strapping a soft foam material selected from a sponge, thermoplastic foam, open cell foam, and expanded polyethylene membrane, on the paper on the substrate.

3. The method of claim 1, further comprising removing the paper from the substrate after the predetermined period of time.

4. The method of claim 1, wherein the reactive polymer includes an epoxy resin.

5. The method of claim 1, wherein the substrate is metal and is selected from the group consisting of steel, aluminum, bronze, and combinations thereof.

6. The method of claim 1, wherein the paper includes the pattern.

7. The method of claim 1, wherein the paper is flat and smooth with no texture.

8. The method of claim 1, wherein the pattern is selected from the group consisting of a faux wood grain design, a faux stone design, a faux rock design, a faux ceramic tile design, a faux granite design, and a faux marble design.

9. The method of claim 1, wherein the predetermined period of time is about 20 minutes, and wherein the predetermined temperature is about 175 to about 185° C.

10. The method of claim 1, further comprising capturing an image of a predetermined pattern, prior to printing the predetermined pattern on the paper.

11. A system for thermal transfer of a pattern on a substrate, the system comprising:
a paper configured for adhering to the, wherein the paper includes a predetermined pattern thereon;
a soft foam material configured for fixing the paper to the substrate; and
an oven configured for baking the substrate for a predetermined period of time and for a temperature lower than a predetermined temperature.

12. The system of claim 11, further comprising an image capture device configured to capture an image of the predetermined pattern.

13. The system of claim 11, wherein the reactive polymer includes an epoxy resin.

14. The system of claim 11, wherein the substrate is metal and is selected from the group consisting of steel, aluminum, bronze, and combinations thereof.

15. The system of claim 11, wherein the paper is adhered to the substrate using a reactive polymer.

16. The system of claim 11, wherein the wherein the soft foam material is selected from a sponge, thermoplastic foam, open cell foam, and expanded polyethylene membrane.

17. The system of claim 11, wherein the predetermined pattern is selected from the group consisting of a faux wood grain design, a faux stone design, a faux rock design, a faux ceramic tile design, a faux granite design, and a faux marble design.

18. The system of claim 11, wherein the predetermined period of time is about 20 minutes.

19. The system of claim 11, wherein the predetermined temperature is about 175 to about 185° C.

20. The system of claim 11, wherein the predetermined pattern is first printed on the paper by a printing machine.
